(19) United States
(12) Patent Application Publication
(10) Pub. No.: US 2001/0033398 A1
(43) Pub. Date: Oct. 25, 2001

(54) Automatic document feeder capable of detecting leading edge of document

(76) Inventor: Michael Chen, Hsinchu (TW)

Correspondence Address: RABIN & CHAMPAGNE, PC, 1101 14TH STREET, NW, SUITE 500, WASHINGTON, DC, 20005, US

(21) Appl. No.: 09/805,579

(22) Filed: Mar. 14, 2001

(30) Foreign Application Priority Data
Apr. 13, 2000 (TW) 89106923

(51) Int. Cl. H04N 1/04

(52) U.S. Cl. 358/498

(57) ABSTRACT

An automatic document feeder includes the roller set for transmitting a document, the paper guide for leading a transmitting direction of the document, and the electronic sensor for detecting a leading edge of the document and also locating a start-to-scan point of the document.

This application incorporates by reference Taiwanese application Ser. No. 089106923, Filed Apr. 13, 2000.

### BACKGROUND OF THE INVENTION

1. Field of the Invention

The invention relates in general to an automatic document feeder capable of detecting the leading edge of the document, and more particularly to an automatic document feeder for an image scanner capable of detecting the leading edge of the document and accurately locating the start-to-scan point of the document.

2. Description of the Related Art

With the rapid evolution of computer technology, consumers increasingly demand quality scan images; therefore, producers endeavor to improve the quality of scan image in terms of image resolution and accuracy.

Recently, image scanners equipped with an automatic document feeder to continuously feed documents to the scanner has been available in the market. The detection of the leading edge of the document and precisely start the scanning operation are key factors in order to achieve a high image resolution.

Referring to FIG. 1, which depicts a partial sectional drawing of a conventional duplex scanner equipped with the automatic document feeder, the document 102 is placed on the sheet feeder plate 104. When the scanning operation is started, the document 102 is delivered into the paper guide 110 and transmitted by the roller set 108 along the transmitting direction of paper guide 110. After document 102 passes through the paper guide 110 and hits the mechanical sensor 112, the mechanical sensor 112 detects the leading edge of the document 102 and sends a pre-starting signal to the carriage 114. The distance between the mechanical sensor 112 and the carriage 114 is fixed, such as L. The fixed value, L, is obtained according to a precise calculation, and preset at the factory. The roller set 108 as driven by a step motor (not shown in FIG. 1) transmits the document 102 from the mechanical sensor 112 to the carriage 114 by controlling the driving steps of the step motor. For example, when the carriage 114 receives a pre-starting signal, the step motor is driven for S steps, resulting in the document 102 being transmitted from the mechanical sensor 112 to the carriage 114; then, the scanner starts to scan the document 102.

Accordingly, the carriage 114 scans the backside of the document 102 while the document 102 is transmitted along the paper guide 110, and the carriage 114 keeps scanning until the document 102 is totally scanned.

Subsequently, the document 102 is transmitted to the carriage 122 by the roller set 118. The distance from the mechanical sensor 112 to the carriage 122 is fixed and preset at the factory. The roller set 118 is also driven by the step motor so that the document 102 is transmitted to the carriage 122 by controlling the driving steps of the step motor, and the carriage 122 starts to scan the front side of the document 102. After the scan action is complete, the document 102 is transmitted out of the paper guide 110 by the roller set 124.

Referring to FIG. 2, which depicts a partial enlarged drawing of the paper guide illustrated in FIG. 1, the flow paths A, B and C which the documents is transmitted along the paper guide are illustrated. In order to transmit the document 102 properly, the mechanical sensor 112 is placed at an angle; hence, when the document 102 is forwarded along the flow path A, B or C, it will hit the point P, Q or R of the mechanical sensor 112, respectively. The straight line L₁ on which the focus of the emitting line from the carriage 114 is located intersects the straight line of the paper guide 110 to form a right angle. The straight line L₂ passes the point R and is perpendicular to the straight line of the paper guide 110. The length between the straight lines L₁ and L₂ is equal to L. When the step motor is driven for S steps, the leading edge of the document 102 is removed from the straight line L₁ to the straight line L₂, wherein the values of L and S are adjusted and fixed as preset values at the factory.

The document forwarded along the flow path C is described below. The flow path C is assumed to be the normal flow path of the document in the operating state that is preset at the factory. The mechanical sensor 112 includes an elastic bar and a revolving spindle. When the document 102 hits the mechanical sensor 112 at the point R, the elastic bar rotates counterclockwise so that the mechanical sensor 112 detects the leading edge of the document 102 and sends a pre-starting signal to the carriage 114. After the step motor is driven for S steps, the document 102 is simultaneously forwarded for a length L, and then the carriage 114 starts to scan the document 102. In other words, the carriage 114 starts to scan the document 102 from the leading edge after the leading edge of the document is transmitted from the point R to the straight line L₁ by the roller set 108.

However, error occurs when the document 102 is forwarded along the other flow path. For example, when the document 102 is forwarded along the flow path A, it hits the mechanical sensor 112 at the point P, subsequently; the mechanical sensor 112 sends the pre-starting signal to the carriage 114. After the step motor is driven for S steps, the document 102 is simultaneously forwarded for a length L, and the carriage 114 starts to scan the document 102; however, the document has already passed the straight line L₂ in the length of PP′, so that part of the document next to the leading edge which is the part in the length PP′ cannot be scanned, resulting in decrease of the image resolution and accuracy.

When the document 102 is forwarded along the flow path B, the similar error occurs as described above, so that part of the document next to the leading edge which is the part in the length QQ′ cannot be scanned.

There are numerous factors that affects the flow path of the document 102 such as the material and condition of the document 102, inner condition of the paper guide, and the material of the roller set 108. For example, the document 102 is liable to be forwarded along the flow path C if the document 102 is made of a soft material; on the contrary, the document 102 is liable to be forwarded along the flow path A if the document 102 is made of a hard material. Moreover, if the document 102 has been used in the automatic document feeder 100 for many times, the leading edge of the document 102 becomes curved or twisted due to repeatedly hitting the mechanical sensor 112. These factors affect the flow path of the document 102, and therefore cause errors.

As can be seen from the above description, the conventional automatic document feeder with a mechanical sensor is inadequate to satisfy the demand for high image resolution and/or scanning accuracy.

Additionally, the method for detecting the leading edge of the document 102 by hitting at the mechanical sensor 112 causes damage to the leading edge of the document 102. When the document 102 is too soft to hit at the mechanical sensor 112 effectively, the leading edge of the document 102 is liable to be deformed and curved due to the pushing force of the roller set.

Furthermore, the waveform of the pre-starting signal is not accurate so that the width and shape of the pulse are not easily controlled, consequently, the timing of carriage 114 that starts the scan of the document 102 is shifted and errors occur.

### SUMMARY OF THE INVENTION

It is therefore an object of the invention to provide an automatic document feeder capable of detecting the leading edge of the document by an electronic sensor, so that the problems resulting from the different flow paths of the document are solved, the physical damage of the document is prevented, a preferred pre-starting signal to control the start-to-scan point of the carriage is accurately produced, and the image quality of the scanner is substantially enhanced.

According to the objective of the invention, an automatic document feeder is provided. The automatic document feeder includes the roller set, the paper guide and the electronic sensor. The roller set transmits the document, the paper guide leads the document along the transmitting direction, and the electronic sensor detects the leading edge of the document and also locates the start-to-scan point of the document.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 is a partial sectional drawing of a conventional duplex scanner equipped with the automatic document feeder;

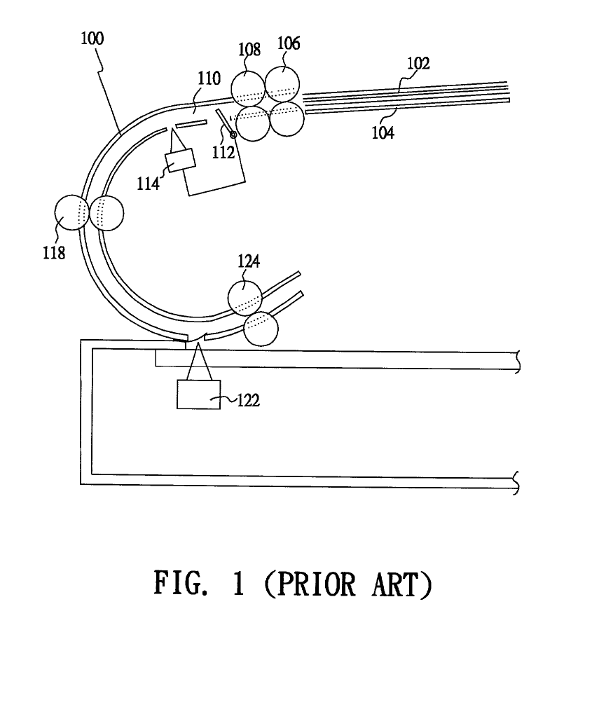

FIG. 2 is a partial enlarged drawing of the paper guide illustrated in FIG. 1;

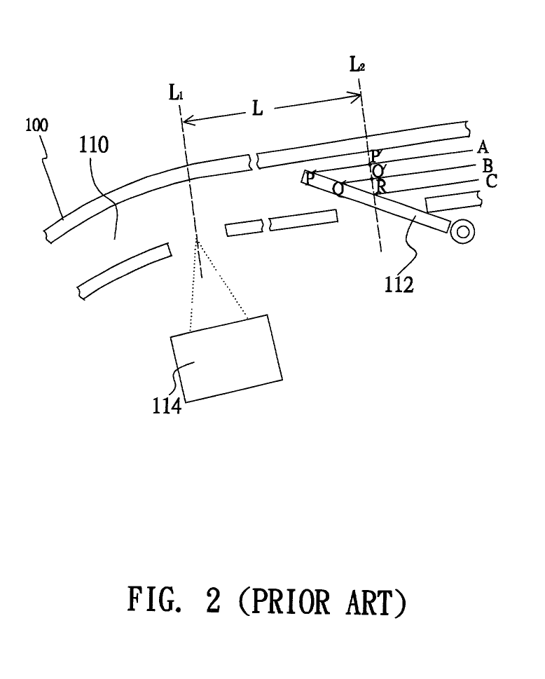

FIG. 3 is a partial sectional drawing of a duplex scanner equipped with the automatic document feeder according to the invention;

FIG. 4 is a partial enlarged drawing of the paper guide illustrated in FIG. 3; and

FIG. 5 is a partial sectional drawing of a single scanner equipped with the automatic document feeder.

### DESCRIPTION OF THE PREFERRED EMBODIMENT

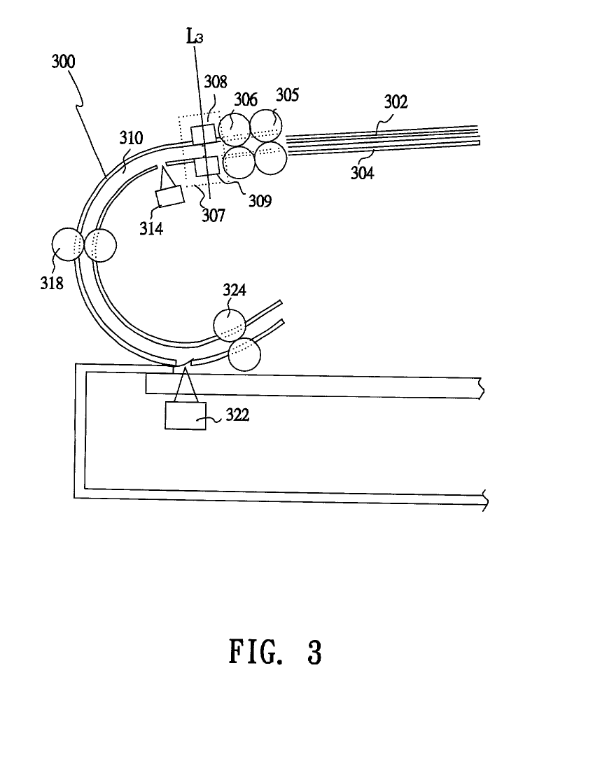

Referring to FIG. 3, which depicts a partial sectional drawing of a duplex scanner equipped with the automatic document feeder according to the invention, the document 302 is placed on the sheet feeder plate 304. When the scanning operation is started, the document 302 is delivered into the paper guide 310, and transmitted along the transmitting direction of paper guide 310 by the roller set 306. The electronic sensor 307, such as a photo sensor, includes a transmitting end 308 and a receiving end 309. The electronic sensor 307 transmits a signal along the direction of the straight line L₃. When the leading edge of the document 302 is forwarded and reaches the straight line L₃, the electronic sensor 307 is capable of detecting the document 302 and subsequently sends a pre-starting signal to the carriage 314, wherein the distance from the electronic sensor 307 to the carriage 314 is fixed as L, a preset value set at the factory. The roller set 306 is driven by the step motor (not shown in FIG. 3) so that the document 302 is transmitted from the electronic sensor 307 to the carriage 314 by controlling the driving steps of the step motor. For example, when the step motor is driven for S steps, the document 302 is exactly transmitted from the position of the electronic sensor 307 to that of the carriage 314.

When the carriage 314 receives a pre-starting signal, the step motor for controlling the roller set 306 is driven for S steps, and then the scanner starts to scan the document 302. Accordingly, the carriage 314 scans the backside of the document 302 while the document 302 is transmitted along the paper guide 310, and the carriage 314 keeps scanning until the document 302 is completely scanned.

Subsequently, the document 302 is transmitted to the carriage 322 by the roller set 318. The distance from the electronic sensor 307 to the carriage 322 is fixed to a preset value set at the factory. The roller set 318 as driven by the step motor (not shown in FIG. 3) transmits the document 302 to the carriage 322 by controlling the driving steps of the step motor, and the carriage 322 starts to scan the front side of the document 302. After the scan action is complete, the document 302 is transmitted out of the paper guide 310 by the roller set 324.

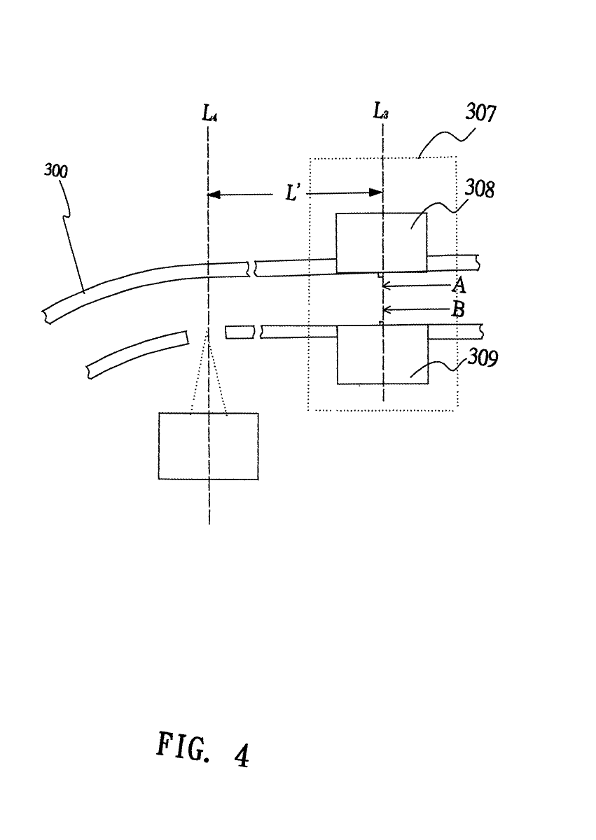

Referring to FIG. 4, which depicts a partial enlarged drawing of the paper guide illustrated in FIG. 3, the transmitting end 308 and the receiving end 309 of the electronic sensor 307 are oppositely set at the sides of the paper guide 310. The transmitting end 308 transmits a signal along the direction of the straight line L₃ to the receiving end 309. The straight line L₃ is perpendicular to the straight line of the paper guide 310. Additionally, the straight line L₄ on which the focus of the emitting line from the carriage 314 is located intersects the straight line of the paper guide 310 to form a right angle.

When the leading edge of the document 302 is forwarded along the paper guide and reaches the straight line L₃, the electronic sensor 307 detects the leading edge of the document 302 and sends a pre-starting signal to the carriage 314. After the step motor is driven for S steps, the leading edge of the document 302 is transmitted to the position of the straight line L₄, and the carriage 314 starts to scan the document 302. Because of the paper guide and the direction of signal transmitting from the electronic sensor are perpendicular to one another, the electronic sensor 307 is able to detect the leading edge of the document 302 whatever the flow path A or B the document 302 is forwarded along. Therefore, the scanner can completely scan the entire content of the document 302 without errors occurring due to the use of the mechanical sensor 112; therefore, the accuracy of detecting the leading edge of the document 302 is greatly improved.

Moreover, the same effects of detecting the leading edge of the document 302 are achieved no matter what the material, the thickness, and the condition of the document 302 are. The leading edge of the document 302 is not deformed or curved due to the use of an electronic sensor 307, and the pre-starting signal sent from the electronic sensor 307 to the carriage 114 can be transformed to obtain a more suitable waveform via the simple signal process. For example, the carriage 314 is triggered while the pulse is changed from low level to high level so that the timing of carriage 114 that starts to scan the document 102 is more accurate.

When the document 302 is transmitted to the carriage 322 by the roller set 318, the effect of accurately locating the start-to-scan point is achieved. The distance from the electronic sensor 307 to the carriage 322 is fixed to a preset value at the factory. After the electronic sensor 307 detects the document 302, the document 302 is transmitted to the carriage 322 by driving the step motor for certain steps; therefore, the carriage 322 capable of starting to scan the leading edge of the document 302 without missing any of the document 302.

In addition, the transmitting end 308 and the receiving end 309 of the electronic sensor 307 can be set at the same side of the paper guide 310 to detect the leading edge of the document 302 and enhance the scanning accuracy.

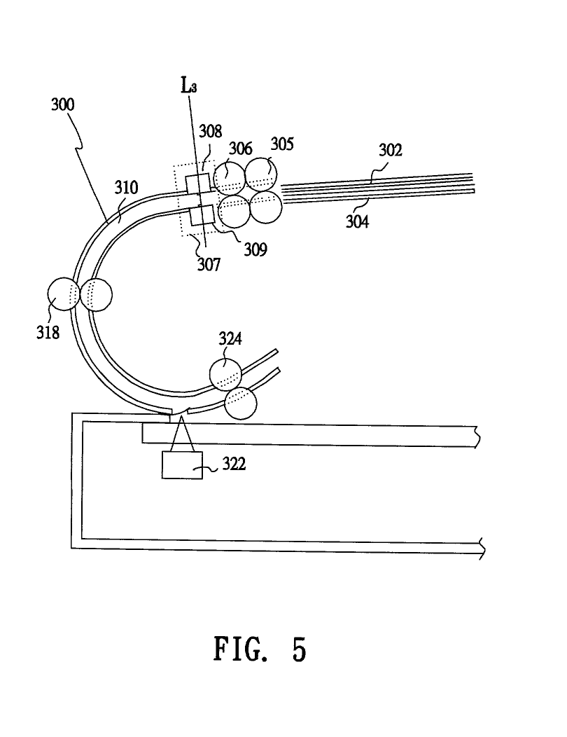

Referring to FIG. 5, which depicts a partial sectional drawing of a single scanner equipped with the automatic document feeder, the difference between FIG. 3 and FIG. 5 is that the automatic document feeder 300 illustrated in FIG. 5 is not equipped with the carriage 314; therefore, the scanner illustrated in FIG. 5 can only scan one side of the document 302 due to the presence of a single carriage 322. However, the higher scanning quality is still achieved by taking advantage of the electronic sensor 307 to accurately locate the start-to-scan point of the document 302.

In the preferred embodiment described herein, the advantage of an automatic document feeder according to the invention is capable of accurately detecting the leading edge of the documents so that the accuracy of the scan quality is greatly enhanced and the probability of errors is decreased.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An automatic document feeder, comprising:
a roller set for transmitting a document;
a paper guide located after the roller set for leading a transmitting direction of the document; and
an electronic sensor located between the roller set and the paper guide for detecting a leading edge of the document and locating a start-to-scan point of the document.

2. The automatic document feeder according to claim 1, wherein the automatic document feeder is applied in a scanner.

3. The automatic document feeder according to claim 2, wherein the scanner is a duplex scanner.

4. The automatic document feeder according to claim 3, wherein the scanner includes a carriage.

5. The automatic document feeder according to claim 1, wherein the automatic document feeder includes a carriage.

6. The automatic document feeder according to claim 1, wherein the electronic sensor is a photo sensor.

7. The automatic document feeder according to claim 6, wherein the electronic sensor further includes a transmitting end and a receiving end.

8. The automatic document feeder according to claim 7, wherein the transmitting end and the receiving end are oppositely set at the sides of the paper guide.

9. The automatic document feeder according to claim 7, wherein the transmitting end and the receiving end are set at the same side of the paper guide.

10. The automatic document feeder according to claim 1, wherein the automatic document feeder is further including a sheet feeder plate for placing the document.
